(19) United States
(12) Patent Application Publication
(10) Pub. No.: US 2016/0052202 A1
(43) Pub. Date: Feb. 25, 2016

(54) JOINED STRUCTURE AND METHOD FOR MANUFACTURING JOINED STRUCTURE

(71) Applicant: OMRON Corporation, Kyoto (JP)

(72) Inventors: Kazuyoshi Nishikawa, Kyoto (JP); Akio Sumiya, Shiga (JP); Satoshi Hirono, Shiga (JP); Tomoyuki Hakata, Kyoto (JP); Hiroshige Uematsu, Kyoto (JP); Kazuhiro Ijiri, Kyoto (JP)

(73) Assignee: OMRON CORPORATION, Kyoto (JP)

(21) Appl. No.: 14/816,776

(22) Filed: Aug. 3, 2015

(30) Foreign Application Priority Data
Aug. 22, 2014 (JP) 2014-169278
May 9, 2015 (JP) 2015-046306

(51) Int. Cl. B29C 65/00; B23K 26/00; B29C 65/18; B29C 65/08; B29C 65/70; B29C 65/16; F16B 5/08; B23K 26/352

(52) U.S. Cl. CPC B29C 66/30325; F16B 5/08; B23K 26/0084; B23K 26/352; B23K 26/0006; B29C 65/08; B29C 65/70; B29C 65/16; B29C 65/18; B29C 66/028; B29C 66/712; B29C 66/742; B23K 2203/42

(57) ABSTRACT

A joined structure has a first member, a second member that is joined together with the first member, and a pore portion formed on the first member and having an opening in a surface of the first member. The pore portion is filled with the second member. The pore portion has an inwardly extending protrusion on an inner periphery thereof.

### BACKGROUND

1. Field

The present invention relates to a joined structure and a method for manufacturing a joined structure.

2. Related Art

A joined structure known in the art may include a first member and a second member formed from dissimilar materials that are joined together (refer to, for example, Patent Literature 1).

Patent Literature 1 describes a technique for joining a dissimilar material, such as resin, to a metallic material. In detail, the surface of a metallic material receives laser scanning performed in a cross pattern to form numerous protrusions (protrusions and recesses) on the surface. When a dissimilar material is joined to the metallic material having such protrusions, the dissimilar material fills the recesses to produce the anchor effect, which improves the bond strength between the metallic material and the dissimilar material.

### CITATION LIST

### Patent Literature

Patent Literature 1: Japanese Patent No. 4020957

### SUMMARY

Although forming protrusions on the surface of the metallic material improves the bond strength in the direction of shear (in the direction of shear along the joint surface) by allowing the dissimilar material to fill the recesses, this structure cannot improve the bond strength in the direction in which the materials separate from each other (in the direction perpendicular to the joint surface).

One or more embodiments of the present invention is directed to a joined structure with improved bond strength in the direction of separation in addition to the direction of shear, and a method for manufacturing such a joined structure.

One or more embodiments of the present invention provides a joined structure including a first member and a second member that are joined together. The first member includes a pore portion having an opening in a surface of the first member. The pore portion is filled with the second member. The pore portion includes an inwardly extending protrusion on an inner periphery thereof.

In this structure, the protrusion is engaged with the second member filling the pore portion in the direction in which the members separate to achieve improved bond strength in the direction of separation. As a result, the structure achieves improved bond strength in the direction of separation in addition to the direction of shear.

In the joined structure, the pore portion may include a first diameter-increasing part and a first diameter-decreasing part that are continuous to each other. The first diameter-increasing part has a larger pore diameter at a position more away from the surface toward a bottom of the pore portion in a depth direction. The first diameter-decreasing part has a smaller pore diameter at a positon more away from the surface toward the bottom in the depth direction. The protrusion may be positioned near the surface.

In the joined structure, the pore portion may include a second diameter-decreasing part, a second diameter-increasing part, and a third diameter-decreasing part that are continuous to one another. The second diameter-decreasing part has a smaller pore diameter at a position more away from the surface toward a bottom of the pore portion in a depth direction. The second diameter-increasing part has a larger pore diameter at a position more away from the surface toward the bottom in the depth direction. The third diameter-decreasing part has a smaller pore diameter at a position more away from the surface toward the bottom in the depth direction. The protrusion may be positioned inward from the surface toward the bottom.

In the joined structure, the first member may include at least one member selected from the group consisting of metals, thermoplastic resins, and thermosetting resins.

In the joined structure, the second member may include at least one member selected from the group consisting of thermoplastic resins and thermosetting resins.

In the joined structure, the pore portion may include a raised portion surrounding the opening. The raised portion extends upward from the surface.

In the joined structure, the pore portion may have an inclined axis relative to the surface.

In the joined structure, the pore portion may include a plurality of the protrusions.

One or more embodiments of the present invention provides a method for manufacturing a joined structure including a first member and a second member that are joined together. The method includes forming a pore portion having an opening in a surface of the first member, forming an inwardly extending protrusion on an inner periphery of the pore portion, and filling the pore portion of the first member with the second member and allowing the second member to solidify.

In this structure, the protrusion is engaged with the second member filling the pore portion in the direction in which the members separate to achieve improved bond strength in the direction of separation. As a result, the structure achieves improved bond strength in the direction of separation in addition to the direction of shear.

The joined structure according to one or more embodiments of the present invention and the method for manufacturing the joined structure according to one or more embodiments of the present invention may achieve improved bond strength in the direction of separation in addition to the direction of shear.

### BRIEF DESCRIPTION OF THE DRAWINGS

FIG. 1 is a schematic cross-sectional view of a joined structure according to a first embodiment of the present invention.

FIG. 2 is a schematic view of a first member having a pore portion in the joined structure shown in FIG. 1.

FIG. 3 is a schematic view of a first member according to a first modification of the first embodiment.

FIG. 4 is a schematic view of a first member according to a second modification of the first embodiment.

FIG. 5 is a schematic view of a first member according to a third modification of the first embodiment.

FIG. 6 is a schematic view of a first member according to a fourth modification of the first embodiment.

FIG. 7 is a perspective view of a first member for a joined structure according to one or more embodiments.

FIG. 8 is a perspective view of a joined structure according to one or more embodiments.

FIG. 9 is a schematic cross-sectional view of a joined structure according to a second embodiment of the present invention.

FIG. 10 is a schematic view of a first member having a pore portion in the joined structure shown in FIG. 9.

FIG. 11 is a schematic view of a first member according to a first modification of the second embodiment.

FIG. 12 is a schematic view of a first member according to a second modification of the second embodiment.

FIG. 13 is a schematic view of a first member according to a third modification of the second embodiment.

FIG. 14 is a schematic view of a first member according to a fourth modification of the second embodiment.

### DETAILED DESCRIPTION

Embodiments of the present invention will now be described with reference to the drawings. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

### First Embodiment

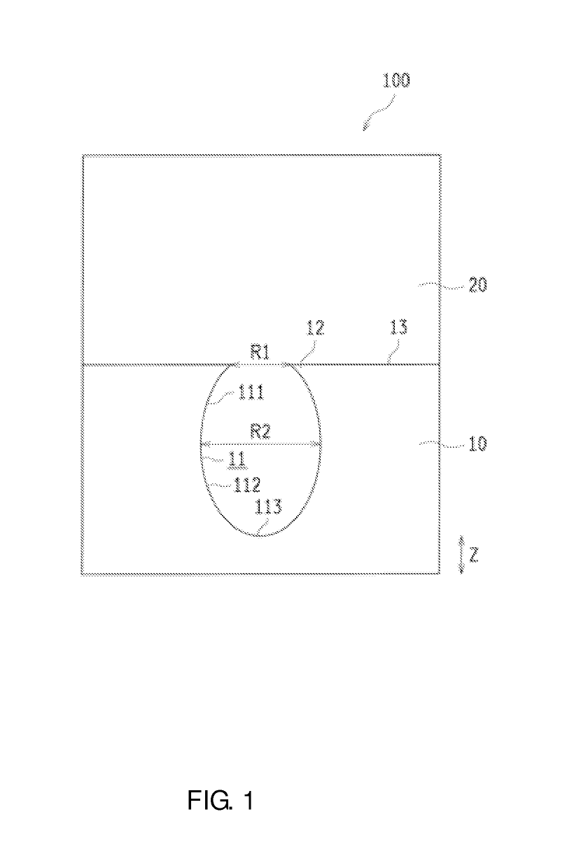

A joined structure 100 according to a first embodiment of the present invention will now be described with reference to FIG. 1.

As shown in FIG. 1, the joined structure 100 includes a first member 10 and a second member 20 formed from dissimilar materials that are joined together. The first member 10 includes a pore portion 11 having an opening in a surface 13. The pore portion 11 has an inwardly extending protrusion 12 on its inner periphery. The pore portion 11 of the first member 10 is filled with the second member 20, which solidifies. Although FIG. 1 is a schematic enlarged view of the joint surface between the first member 10 and the second member 20 and shows a single pore portion 11, the structure actually includes a plurality of pore portions 11.

The first member 10 is formed from at least one material selected from metals, thermoplastic resins, and thermosetting resins. The second member 20 is formed from at least one material selected from thermoplastic resins and thermosetting resins.

The metals include ferrous metals, stainless steel metals, copper metals, aluminum metals, magnesium metals, and alloys of these metals. The metals further include metal compacts such as die-cast zinc, die-cast aluminum, or powder-metallurgy compacts.

The thermoplastic resins include polyvinyl chloride (PVC), polystyrene (PS), styrene acrylonitrile (SAN), acrylonitrile butadiene styrene (ABS), polymethylmethacrylate (PMMA), polyethylene (PE), polypropylene (PP), polycarbonate (PC), modified polyphenylene ether (m-PPE), polyamide 6 (PA6), polyamide 66 (PA66), polyacetal (POM), polyethylene terephthalate (PET), polybutylene terephthalate (PBT), polysulfone (PSF), polyarylate (PAR), polyetherimide (PEI), polyphenylene sulfide (PPS), polyethersulfone (PES), polyetheretherketone (PEEK), polyamide-imide (PAI), liquid crystal polymers (LCP), polyvinylidene chloride (PVDC), polytetrafluoroethylene (PTFE), polychlorotrifluoroethene (PCTFE), and polyvinylidene fluoride (PVDF). The thermoplastic resins further include thermoplastic elastomers (TPE), such as TPO (olefinic), TPS (styrenic), TPEE (ester), TPU (urethane), TPA (nylon), and TPVC (vinyl chloride).

The thermosetting resins include epoxy resins (EP), polyurethane (PUR), urea-formaldehyde (UF), melamine formaldehyde (MF), phenol formaldehyde (PF), unsaturated polyester resins (UP), and silicone (SI). The thermosetting resins further include fiber-reinforced plastic (FRP).

The thermoplastic resins and the thermosetting resins may contain fillers. The fillers include inorganic fillers, such as glass fibers or mineral salts, and include metallic fillers, organic fillers, and carbon fibers.

The pore portion 11 is a non-through hole that is substantially circular as viewed from above. The first member 10 includes a plurality of pore portions 11 in the surface 13. The pore portion 11 may have a pore diameter R1 at the surface 13 in a range of 30 to 100 μm, inclusive. With the pore diameter R1 smaller than 30 μm, the pore portion 11 would not be filled sufficiently with the second member 20. This reduces the anchor effect. With the pore diameter R1 greater than 100 μm, fewer pore portions 11 would be formed per unit area. This reduces the anchor effect.

The interval between the pore portions 11 (the distance between the center of a predetermined pore portion 11 and the center of a pore portion 11 adjacent to the predetermined pore portion 11) may be less than or equal to 200 μm. With the interval between the pore portions 11 greater than 200 μm, fewer pore portions 11 would be formed per unit area. This reduces the anchor effect. The smallest possible interval between the pore portions 11 may be the distance at which the pore portions 11 are closest without communicating with each other. The pore portions 11 may be at equal intervals to allow the bond strength to be isotropic in the direction of shear.

In the first embodiment, each pore portion 11 includes a diameter-increasing part 111, which has a larger pore diameter at a position more away from the surface 13 toward a bottom 113 in the depth direction (Z-direction), and a diameter-decreasing part 112, which has a smaller pore diameter at a position more away from the surface 13 toward the bottom 113 in the depth direction. The diameter-increasing part 111 and the diameter-decreasing part 112 are continuous to each other. The diameter-increasing part 111 increases its diameter and has a curved profile. The diameter-decreasing part 112 decreases its diameter and has a curved profile. The diameter-increasing part 111 is one example of a first diameter-increasing part of one or more embodiments of the present invention. The diameter-decreasing part 112 is one example of a first diameter-decreasing part of one or more embodiments of the present invention.

The diameter-increasing part 111 is nearer the surface 13, whereas the diameter-decreasing part 112 is nearer the bottom 113. The pore portion 11 has the largest pore diameter (inner diameter) R2 at the interface between the diameter-increasing part 111 and the diameter-decreasing part 112. The pore diameter R1 is smaller than the pore diameter R2. This forms the protrusion 12 near the surface 13 of the first member 10. In one embodiment, the protrusion 12 extends annularly across the entire circumference of the pore portion.

The inwardly extending protrusion 12 on the inner periphery of the pore portion 11 is engaged with the second member 20 filling the pore portion 11 in the direction of separation (Z-direction), and improves the bond strength in the direction of separation. As a result, this structure achieves improved bond strength in the direction of separation in addition to the direction of shear. This structure can maintain the bond strength against stress acting to separate the first member 10 and the second member 20 under thermal cycling conditions due to the different linear expansion coefficients of the first and second members 10 and 20. In other words, this structure has high durability under thermal cycling conditions.

The pore portions 11 may be formed by laser irradiation using a laser with pulsed operation. Examples of such lasers include a fiber laser, a YAG laser, a YVO₄ laser, a semiconductor laser, a carbon dioxide gas laser, and an excimer laser. Among these, a fiber laser, a YAG laser, a second harmonic of a YAG laser, a YVO₄ laser, and a semiconductor laser have intended wavelengths. The output of the laser is set based on the diameter of light emitted from the laser, the material of the first member 10, and the dimensions of the first member 10 (e.g., thickness). The maximum output of the laser may be, for example, 40 W. With the laser output higher than 40 W, the energy would be too large to form the pore portion 11 having the protrusion 12.

The pore portion 11 may be formed using a fiber laser marker, such as the fiber laser marker MX-Z2000 or MX-Z2050 (OMRON Corporation). These fiber laser markers can produce laser light having each pulse including a plurality of subpulses. These laser makers allow the energy of the laser light to easily concentrate in the depth direction, and thus are suitable for forming the pore portion 11. More specifically, when irradiated with laser light, the first member 10 melts locally to form the pore portion 11. With this laser light having a plurality of subpulses, the molten portion of the first member 10 does not diffuse easily and is easily deposited around the pore portion 11. As the pore portion 11 forms, the molten portion of the first member 10 is deposited inside the pore portion 11 to form the protrusion 12. The laser irradiation is performed in, for example, a direction perpendicular to the surface 13 to form the pore portion 11 with the central axis perpendicular to the surface 13.

One cycle of subpulses may be less than or equal to 15 ns under the processing conditions of the fiber laser marker. If one cycle of subpulses is greater than 15 ns, the energy easily diffuses due to heat conduction, and disables easy formation of the pore portion 11 having the protrusion 12. One cycle of subpulses is the sum of the irradiation time of subpulses per operation and the time taken from the end of the subpulse irradiation operation to the start of the next irradiation operation.

One pulse may include 2 to 50 subpulses under the processing conditions of the fiber laser marker. If one pulse includes more than 50 subpulses, the small output per unit of subpulses would disable easy formation of the pore portion 11 having the protrusion 12.

The second member 20 is joined to the surface 13 of the first member 10 including the pore portions 11. The second member 20 is joined to the first member 10 by, for example, injection molding, hot plate welding, laser welding, mold curing, ultrasonic welding, or vibration welding. The second member 20 filling the pore portions 11 solidifies.

This joined structure 100 can be used for joining a resin cover (not shown) to a metallic case (not shown) of a photoelectric sensor. The metallic case corresponds to the first member 10. The resin cover corresponds to the second member 20.

### Method for Manufacturing the Joined Structure

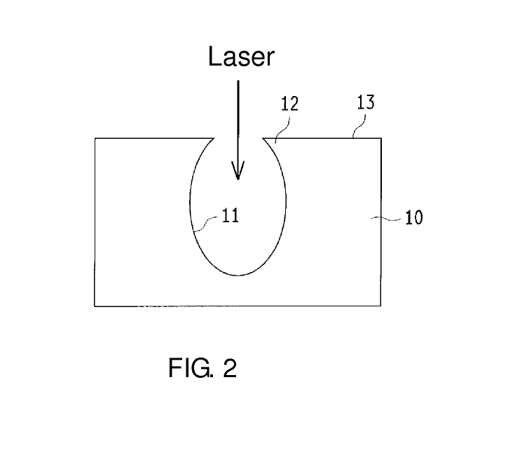

A method for manufacturing the joined structure 100 according to the first embodiment will now be described with reference to FIGS. 1 and 2.

First, the pore portions 11 are formed on the surface 13 of the first member 10, and the protrusion 12 is formed on the inner periphery of each pore portion 11. As shown in FIG. 2, for example, the pore portion 11 and the protrusion 12 are formed by irradiation of laser light having pulses each including a plurality of subpulses. For example, the pore portion 11 and the protrusion 12 are formed using the fiber laser marker MX-Z2000 or MX-Z2050 described above.

Each pore portion 11 of the first member 10 is filled with the second member 20. The second member 20 then solidifies. This joins the first member 10 and the second member 20 to form the joined structure 100 (refer to FIG. 1). The second member 20 may be joined by, for example, injection molding, hot plate welding, laser welding, mold curing, ultrasonic welding, or vibration welding.

### Modifications of the First Member

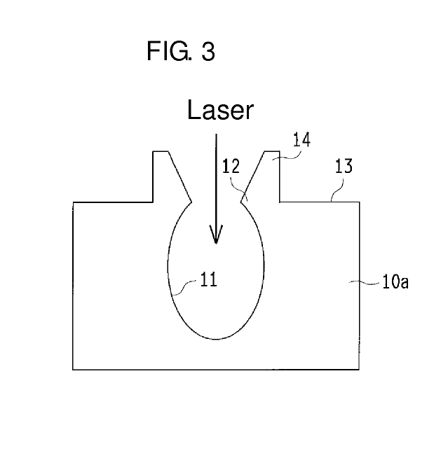

Modifications of the first member 10 will now be described with reference to FIGS. 3 to 6.

FIG. 3 is a schematic view of a first member 10a according to a first modification of the first embodiment. The first member 10a shown in FIG. 3 includes the pore portion 11 having a raised portion 14 surrounding the opening and extending upward from the surface 13. The raised portion 14 surrounds the pore portion 11, and is substantially circular as viewed from above. The raised portion 14 may be formed by depositing the molten first member 10a during laser irradiation of laser light having pulses with a plurality of subpulses. In this structure, the raised portion 14 additionally produces the anchor effect, and increases the bond strength further.

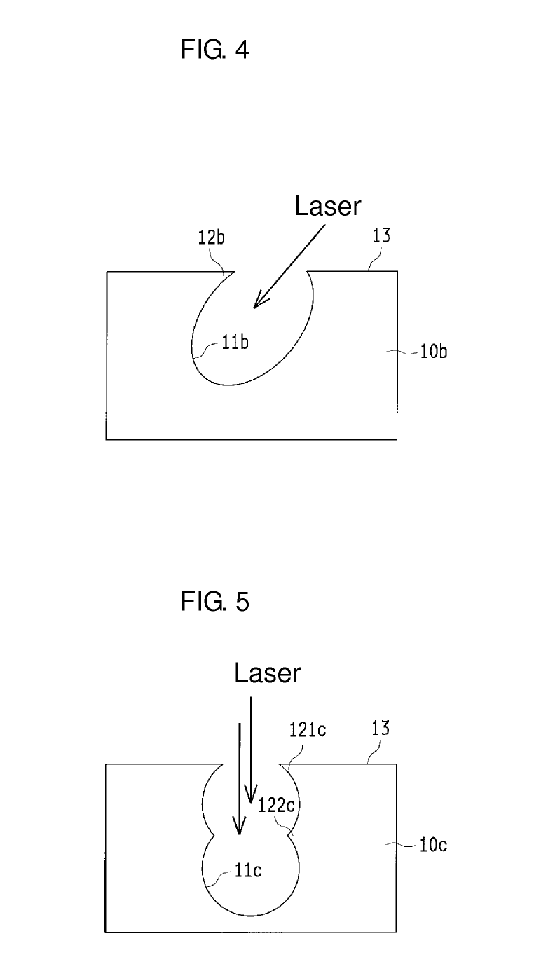

FIG. 4 is a schematic view of a first member 10b according to a second modification of the first embodiment. The first member 10b shown in FIG. 4 includes a pore portion 11b having an inclined central axis relative to the surface 13. The pore portion 11b has an inwardly extending protrusion 12b on the inner periphery. The pore portion 11b is formed by, for example, laser irradiation performed in a direction inclined relative to the surface 13 (at angles of 45 to 90 degrees inclusive). This allows formation of the pore portion 11b in the presence of an obstruction above the surface area.

FIG. 5 is a schematic view of a first member 10c according to a third modification of the first embodiment. The first member 10c shown in FIG. 5 includes a pore portion 11c having a plurality of protrusions 121c and 122c. The pore portion 11c may be formed by, for example, laser irradiation with different laser output conditions applied to the same area. This structure increases the surface area of the pore portion 11c. The protrusions 121c and 122c further increase the bond strength. Although FIG. 5 shows the two protrusions 121c and 122c, three or more protrusions may be formed.

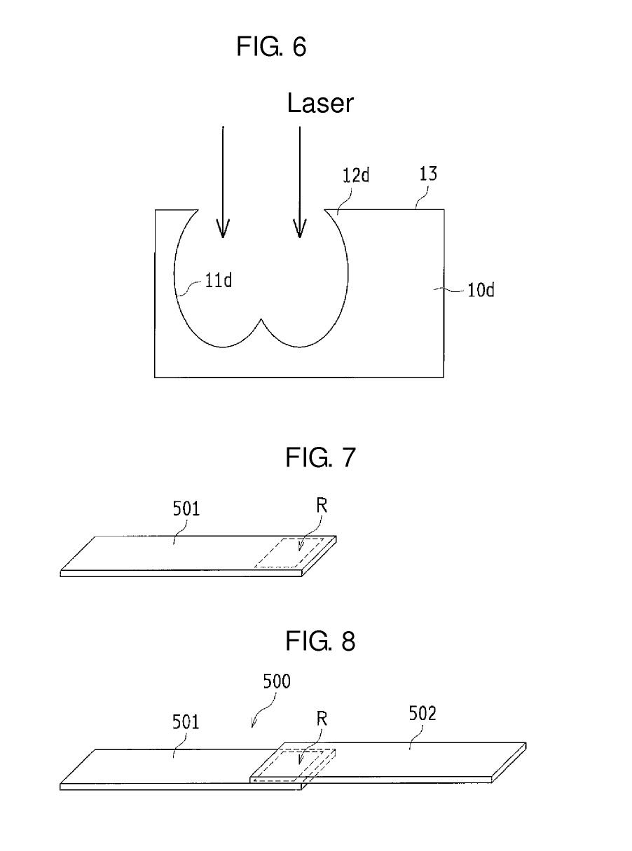

FIG. 6 is a schematic view of a first member 10d according to a fourth modification of the first embodiment. The first member 10d shown in FIG. 6 includes a single pore portion 11d that is formed by laser irradiation applied a plurality of times to different areas. The plurality of pore portions formed through such laser irradiation overlap and communicate with one another to form the single pore portion 11d. The pore portion 11d has an inwardly extending protrusion 12d on its inner periphery.

The first to fourth modifications described above may be combined with one another.

### Experiments

Experiments 1 and 2 conducted to verify the advantages of the first embodiment will now be described with reference to FIGS. 7 and 8.

### Experiment 1

In Experiment 1, a joined structure 500 of example 1 corresponding to the first embodiment (refer to FIG. 8) and a joined structure of comparative example 1 were prepared. The joints of these structures were evaluated. For this evaluation, the bond strength at the joint of each structure was measured before and after the thermal shock test. Based on the measurement results, each structure was determined either acceptable or rejectable. Table 1 shows the evaluation results.

TABLE 1

| | | | | Comparative |
|---|---|---|---|---|
| | | | Example 1 | Example 1 |
| First Member | | | AI | AI |
| Second Member | | | PBT | PBT |
| Laser | | | With Pulse | Without |
| | | | Control | Pulse Control |
| Pore Shape | Pore Diameter R1 at Surface | | 55 μm | 73 μm |
| | Pore Diameter (Inner | | 62 μm | N/A |
| | Diameter) R2 | | | |
| | Depth | | 87 μm | 53 μm |
| Bond | Bond Strength | Shear | 16.8 MPa | 9.4 MPa |
| Performance | (Before | Separation | 1.00 MPa | 0.64 MPa |
| | Thermal Shock | | | |
| | Test) | | | |
| | Bond Strength | Shear | 16.0 MPa | 5.1 MPa |
| | (After Thermal | Separation | 0.98 MPa | 0.15 MPa |
| | Shock Test) | | | |
| | Ratio of | Shear | 95% | 54% |
| | Change in | Separation | 98% | 23% |
| | Bond Strength | | | |

| | | |
|---|---|---|
| Evaluation Result | Acceptable | Rejectable |

A method for preparing the joined structure 500 of example 1 will now be described.

The first member 501 of the joined structure 500 of example 1 is formed from Al (A5052). As shown in FIG. 7, the first member 501 is a plate with a length of 100 mm, a width of 29 mm, and a thickness of 3 mm.

A predetermined area R of the surface of the first member 501 is irradiated with laser light. The predetermined area R is a joint area of the joined structure 500. The area R has a size of 12.5×20 mm. The laser irradiation is performed using the fiber laser marker MX-Z2000 (OMRON Corporation) under the conditions below.

### Laser Irradiation Conditions

Laser: Fiber Laser (with a wavelength of 1062 nm)
Frequency: 10 kHz
Output: 3.0 W
Scan Speed: 650 mm/sec
Scan Number: 20 times
Irradiation Interval: 65 μm
Number of Subpulses: 20

The frequency refers to the frequency of a pulse including a plurality of subpulses (20 subpulses in this example). Under these irradiation conditions, laser light (pulses) is applied ten thousand times at intervals of 65 μm while moving by 650 mm per second. Each pulse includes 20 subpulses. The scan number refers to the number of times the laser light is applied repeatedly at the same position.

Applying laser light having pulses with a plurality of subpulses forms pore portions in the predetermined area R of the surface of the first member 501, and also forms a protrusion in each pore portion at a position near the surface. As shown in Table 1, each pore portion has the pore diameter R2 at the interface between the diameter-increasing part and the diameter-decreasing part (refer to FIG. 1) greater than the pore diameter R1 at the surface (refer to FIG. 1).

The second member 502 is then joined to the surface of the first member 501 by insert molding. The second member 502 of the joined structure 500 of example 1 is formed from PBT (Duranex® 3316 by WinTech Polymer Ltd.). The molding is performed using the molding machine J35EL3 (The Japan Steel Works, Ltd.) under the conditions below.

### Molding Conditions

Preliminary Drying: 120° C.×5 hours
Mold Temperature: 120° C.
Cylinder Temperature: 270° C.
Dwell Pressure: 100 MPa

In the joined structure 500 of example 1 prepared as above, the second member 502 is a plate with a length of 100 mm, a width of 25 mm, and a thickness of 3 mm.

A method for preparing the joined structure of comparative example 1 will now be described.

The joined structure of comparative example 1 uses the materials for the first member and the second member identical to the materials used in example 1, and uses the same molding conditions as in the above example. For the joined structure of comparative example 1, pore portions were formed with a fiber laser without pulse control. More specifically, the pore portions were formed by irradiation of laser light having pulses with no subpulses. Each pore portion in the first member of comparative example 1 has a bowl-like shape (conical). As shown in Table 1, the first member of comparative example 1 has no inwardly extending protrusion on the inner periphery, and thus has no dimension corresponding to the pore diameter R2 of example 1.

The joints of the joined structure 500 of example 1 and the joined structure of comparative example 1 were evaluated.

The bond strength was measured using the 5900 series electromechanical universal testing machine (Instron Corporation). More specifically, the structures underwent a tensile test in the direction of shear at a tensile loading speed of 5 mm/min, and underwent a three-point bending test in the direction of separation (vertical direction) at a crosshead speed of 2 mm/min. The tests were terminated when fracture occurred in the second member or at the joint surface. The maximum strength in the test was determined as the bond strength of the structure.

The thermal shock test was conducted using the thermal shock testing machine TSD-100 (ESPEC Corp.). More specifically, the structures were exposed to alternating low temperatures of −40° C. for 30 minutes and high temperatures of 85° C. for 30 minutes 100 times.

To determine the reliability under thermal cycling conditions, each structure was determined either acceptable or rejectable based on the criteria below.

Acceptable: the bond strength after the thermal shock test/the bond strength before the thermal shock test ≧90%
Rejectable: the bond strength after the thermal shock test/the bond strength before the thermal shock test <90%

As shown in Table 1 above, before the thermal shock test, the joined structure 500 of example 1 has a higher bond strength both in the direction of shear and in the direction of separation than the joined structure of comparative example 1. This reveals that forming the protrusion at the inner periphery of each pore portion in the joined structure 500 of example 1 improves the bond strength. After the thermal shock test, the joined structure 500 of example 1 also shows a higher bond strength both in the direction of shear and in the direction of separation than the joined structure of comparative example 1.

The results further reveal that the joined structure 500 of example 1 can maintain the bond strength after the thermal shock test to at least 90% of the bond strength before the thermal shock test. In contrast, the joined structure of comparative example 1 has a substantially lower bond strength after the thermal shock test. This reveals that forming the protrusion on the inner periphery of each pore portion in the joined structure 500 of example 1 improves the durability of the structure under thermal cycling conditions.

### Experiment 2

In Experiment 2, a joined structure according to example 2 corresponding to the first embodiment and a joined structure according to comparative example 2 were prepared. The joints of these structures were evaluated. The joint evaluation was conducted in the same manner as in Experiment 1. Table 2 shows the experimental results.

TABLE 2

| | | | | Comparative |
|---|---|---|---|---|
| | | | Example 2 | Example 2 |
| First Member | | | PPS | PPS |
| Second Member | | | PBT | PBT |
| Laser | | | With Pulse | Without |
| | | | Control | Pulse Control |
| Pore Shape | Pore Diameter R1 at Surface | | 54 μm | 72 μm |
| | Pore Diameter (Inner | | 59 μm | N/A |
| | Diameter) R2 | | | |
| | Depth | | 65 μm | 35 μm |
| Bond | Bond Strength | Shear | 15.4 MPa | 10.2 MPa |
| Performance | (Before Thermal | Separation | 0.84 MPa | 0.23 MPa |
| | Shock Test) | | | |
| | Bond Strength | Shear | 14.7 MPa | 4.1 MPa |
| | (After Thermal | Separation | 0.81 MPa | 0.07 MPa |
| | Shock Test) | | | |
| | Ratio of Change | Shear | 95% | 40% |
| | in Bond Strength | Separation | 96% | 30% |

| | | |
|---|---|---|
| Evaluation Result | Acceptable | Rejectable |

Experiment 2 uses the material for the first member and the conditions for laser irradiation different from those in Experiment 1. More specifically, the first member of the joined structure of example 2 is formed from PPS (FORTRON® 1140 by Polyplastics Co., Ltd.). The laser irradiation is performed under the conditions below.

### Laser Irradiation Conditions

Laser: Fiber Laser (with a wavelength of 1062 nm)
Frequency: 10 kHz
Output: 1.1 W
Scan Speed: 650 mm/sec
   Scan Number: 3 times
Irradiation Interval: 65 μm
Number of Subpulses: 3

As shown in Table 2 above, before the thermal shock test, the joined structure of example 2 has a higher bond strength both in the direction of shear and in the direction of separation than the joined structure of comparative example 2. The results further reveal that the joined structure of example 2 can maintain the bond strength after the thermal shock test to at least 90% of the bond strength before the thermal shock test. In other words, Experiment 2 yields the results similar to the results obtained in Experiment 1. In the structure including the first member made of PPS resin, forming the protrusion on the inner periphery of each pore portion improves the bond strength, and improves the durability of the structure under thermal cycling conditions.

### Second Embodiment

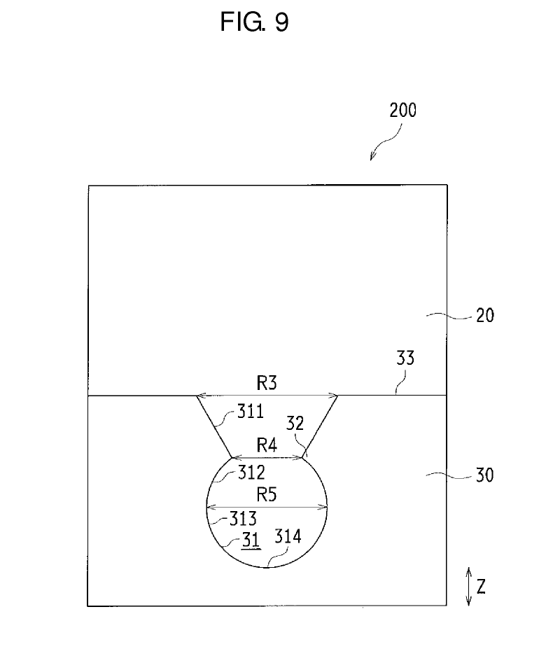

Referring now to FIG. 9, a joined structure 200 according to a second embodiment of the present invention will now be described.

As shown in FIG. 9, the joined structure 200 includes a first member 30 and a second member 20 formed from dissimilar materials that are joined together. The first member 30 includes a pore portion 31 having an opening in a surface 33. The pore portion 31 has an inwardly extending protrusion 32 on its inner periphery. The pore portion 31 of the first member 30 is filled with the second member 20, which solidifies.

In the second embodiment, the pore portion 31 includes a diameter-decreasing part 311, which has a smaller pore diameter at a position more away from the surface 33 toward a bottom 314 in the depth direction (Z-direction), a diameter-increasing part 312, which has a larger pore diameter at a position more away from the surface 33 toward the bottom 314 in the depth direction (Z-direction), and a diameter-decreasing part 313, which has a smaller pore diameter at a position more away from the surface 33 toward the bottom 314. The diameter-decreasing part 311, the diameter-increasing part 312, and the diameter-decreasing part 313 are continuous to one another. The diameter-decreasing part 311 decreases its diameter and has a straight profile. The diameter-increasing part 312 increases its diameter and has a curved profile. The diameter-decreasing part 313 decreases its diameter and has a curved profile. The diameter-decreasing part 311 is one example of a second diameter-decreasing part of one or more embodiments of the present invention. The diameter-increasing part 312 is one example of a second diameter-increasing part of one or more embodiments of the present invention. The diameter-decreasing part 313 is one example of a third diameter-decreasing part of one or more embodiments of the present invention.

The diameter-decreasing part 311, the diameter-increasing part 312, and the diameter-decreasing part 313 are positioned in the stated order from the surface 33 toward the bottom 314. The pore portion 31 has a pore diameter (inner diameter) R4 at the interface between the diameter-decreasing part 311 and the diameter-increasing part 312. The pore diameter R4 is smaller than a pore diameter R3 at the surface 33 and a pore diameter R5 at the interface between the diameter-increasing part 312 and the diameter-decreasing part 313. As a result, the protrusion 32 is positioned inward from the surface toward the bottom 314. In one embodiment, the protrusion 32 extends annularly across the entire circumference of the pore portion.

The other components of the first member 30 are the same as the components of the first member 10.

As described above, the inwardly extending protrusion 32 on the inner periphery of the pore portion 31 is engaged with the second member 20 filling the pore portion 31 in the direction of separation (Z-direction), and improves the bond strength in the direction of separation. As a result, this structure achieves improved bond strength in the direction of separation in addition to the direction of shear. This structure can maintain the bond strength against stress acting to separate the first member 30 and the second member 20 under thermal cycling conditions due to the different linear expansion coefficients of the first and second members 30 and 20. In other words, this structure has high durability under thermal cycling conditions.

Method for Manufacturing the Joined structure

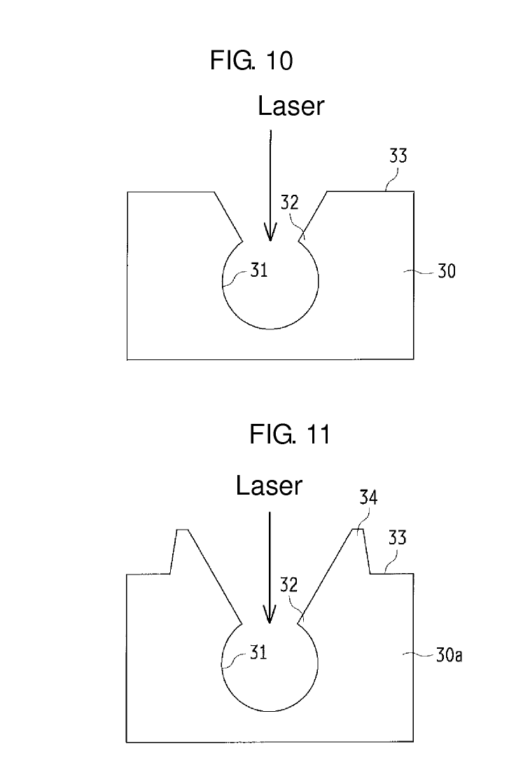

A method for manufacturing the joined structure 200 according to the second embodiment will now be described with reference to FIGS. 9 and 10.

First, the pore portions 31 are formed on the surface 33 of the first member 30, and the protrusion 32 is formed on the inner periphery of each pore portion 31. As shown in FIG. 10, for example, the pore portion 31 and the protrusion 32 are formed by irradiation of laser light having pulses each including a plurality of subpulses. For example, the pore portion 31 and the protrusion 32 are formed using the fiber laser marker MX-Z2000 or MX-Z2050 described above. Unlike in the first embodiment, the protrusion 32 in the second embodiment is positioned inward from the surface toward the bottom 314. This difference may be created by the different material of the first member 30 or the different conditions for laser irradiation.

Each pore portion 31 of the first member 30 is filled with the second member 20. The second member 20 then solidifies. This joins the first member 30 and the second member 20 to form the joined structure 200 (refer to FIG. 9). The second member 20 may be joined by, for example, injection molding, hot plate welding, laser welding, mold curing, ultrasonic welding, or vibration welding.

### Modifications of the First Member

Modifications of the first member 30 will now be described with reference to FIGS. 11 to 14.

FIG. 11 is a schematic view of a first member 30a according to a first modification of the second embodiment. The first member 30a shown in FIG. 11 includes the pore portion 31 having a raised portion 34 surrounding the opening and extending upward from the surface 33. The raised portion 34 surrounds the pore portion 11, and is substantially circular as viewed from above. The raised portion 34 may be formed by depositing the molten first member 30a during laser irradiation of laser light having pulses with a plurality of subpulses. In this structure, the raised portion 34 additionally produces the anchor effect, and increases the bond strength further.

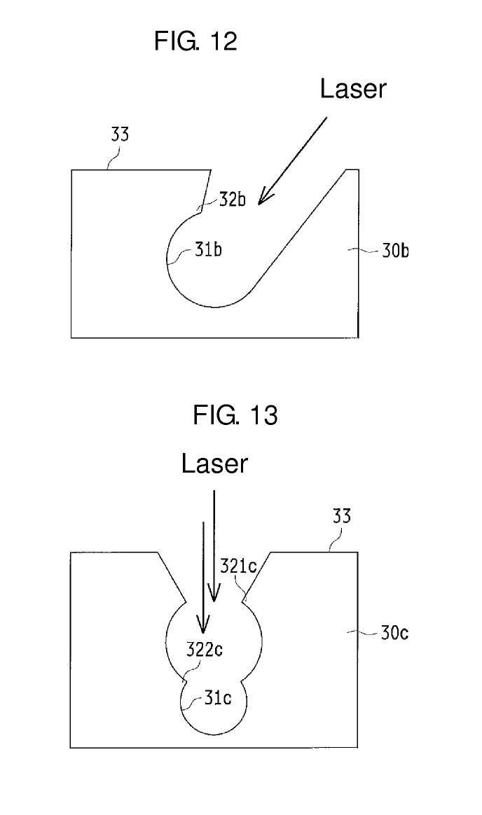

FIG. 12 is a schematic view of a first member 30b according to a second modification of the second embodiment. The first member 30b shown in FIG. 12 includes a pore portion 31b having an inclined central axis relative to the surface 33. The pore portion 31b has an inwardly extending protrusion 32b on the inner periphery. The pore portion 31b is formed by, for example, laser irradiation performed in a direction inclined relative to the surface 33 (at angles of 45 to 90 degrees inclusive). This allows formation of the pore portion 31b in the presence of an obstruction above the surface area.

FIG. 13 is a schematic view of a first member 30c according to a third modification of the second embodiment. The first member 30c shown in FIG. 13 includes a pore portion 31c having a plurality of protrusions 321c and 322c. The pore portion 31c may be formed by, for example, laser irradiation with different laser output conditions applied to the same area. This structure increases the surface area of the pore portion 31c. The protrusions 321c and 322c further increase the bond strength. Although FIG. 13 shows the two protrusions 321c and 322c, three or more protrusions may be formed.

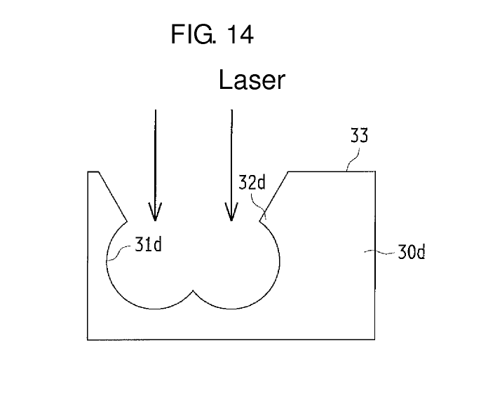

FIG. 14 is a schematic view of a first member 30d according to a fourth modification of the second embodiment. The first member 30d shown in FIG. 14 includes a single pore portion 31d formed by laser irradiation applied a plurality of times to different areas. The plurality of pore portions formed through such laser irradiation overlap and communicate with one another to form the single pore portion 31d. The pore portion 31d has an inwardly extending protrusion 32d on the inner periphery.

The first to fourth modifications described above may be combined with one another.

### Experiments

Experiment 3 conducted to verify the advantages of the second embodiment will now be described.

In Experiment 3, a joined structure of example 3 corresponding to the second embodiment and a joined structure of comparative example 3 were prepared. The joints of these structures were evaluated. The joint evaluation was conducted in the same manner as in Experiment 1. Table 3 shows the evaluation results.

TABLE 3

| | | | | Comparative |
|---|---|---|---|---|
| | | | Example 3 | Example 3 |
| First Member | | | SUS | SUS |
| Second Member | | | PBT | PBT |
| Laser | | | With Pulse | Without Pulse |
| | | | Control | Control |
| Pore Shape | Pore Diameter R3 at Surface | | 54 μm | 66 μm |
| | Pore Diameter (Inner | | 47 μm | N/A |
| | Diameter) R4 | | | |
| | Pore Diameter (Inner | | 56 μm | N/A |
| | Diameter) R5 | | | |
| | Depth | | 49 μm | 32 μm |
| Bond | Bond Strength | Shear | 19.0 MPa | 8.6 MPa |
| Performance | (Before Thermal | Separation | 0.66 MPa | 0.23 MPa |
| | Shock Test) | | | |
| | Bond Strength | Shear | 17.9 MPa | 4.6 MPa |
| | (After Thermal | Separation | 0.63 MPa | 0.11 MPa |
| | Shock Test) | | | |
| | Ratio of Change | Shear | 94% | 53% |
| | in Bond Strength | Separation | 95% | 48% |

| | | |
|---|---|---|
| Evaluation Result | Acceptable | Rejectable |

Experiment 3 uses the material for the first member and the conditions for laser irradiation different from those used in Experiment 1. More specifically, the first member of the joined structure of example 3 is formed from SUS304. The laser irradiation is performed under the conditions below.

### Laser Irradiation Conditions

Laser: Fiber Laser (with a wavelength of 1062 nm)
Frequency: 10 kHz
Output: 3.8 W
Scan Speed: 650 mm/sec

Scan Number: 20 times
Irradiation Interval: 65 μm
Number of Subpulses: 20

The joined structure of example 3 undergoes irradiation of laser light having pulses each including a plurality of subpulses. This forms pore portions in the surface of the first member, and also forms a protrusion in each pore portion at a position inward from the surface. As shown in Table 3, the pore diameter R4 (refer to FIG. 9) is smaller than the pore diameter R3 at the surface (refer to FIG. 9) and the pore diameter R5 (refer to FIG. 9). Each pore portion in the first member of comparative example 3 has a bowl-like shape (conical). The first member of comparative example 3 has no dimension corresponding to the pore diameters R4 and R5 of example 3.

As shown in Table 3 above, before the thermal shock test, the joined structure of example 3 has a higher bond strength both in the direction of shear and in the direction of separation than the joined structure of comparative example 3. The results further reveal that the joined structure of example 3 can maintain the bond strength after the thermal shock test to at least 90% of the bond strength before the thermal shock test. In other words, Experiment 3 yields the results similar to the results of Experiment 1. More specifically, the protrusions formed at positions inward from the surface toward the bottom improve the bond strength, and improve the durability of the structure under thermal cycling conditions.

### Other Embodiments

The embodiments disclosed are to be considered in all respects as illustrative and not restrictive. The technical scope of the invention is defined by the appended claims and not construed by the embodiments. The technical scope of the invention includes all changes that come within the meaning and range of equivalency of the claims.

For example, the surface 13 may be flat or curved in the first embodiment. The same applies to the second embodiment.

Although the diameter-increasing part 111 and the diameter-decreasing part 112 are continuous to each other in the first embodiment, another part that is straight in the depth direction may be formed between the diameter-increasing part and the diameter-decreasing part. The same applies to the second embodiment.

One or more embodiments of the present invention may applicable to a joined structure including a first member and a second member formed from dissimilar materials that are joined together, and a method for manufacturing the joined structure.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

### REFERENCE SIGNS LIST

10, 10a, 10b, 10c, 10d first member
11, 11b, 11c, 11d pore portion
12, 12b, 121c, 122c, 12d protrusion
13 surface
14 raised portion
20 second member
30, 30a, 30b, 30c, 30d first member
31, 31b, 31c, 31d pore portion
32, 32b, 321 c, 322c, 32d protrusion
33 surface
34 raised portion
100 joined structure
111 diameter-increasing part (first diameter-increasing part)
112 diameter-decreasing part (first diameter-decreasing part)
113 bottom
200 joined structure
311 diameter-decreasing part (second diameter-decreasing part)
312 diameter-increasing part (second diameter-increasing part)
313 diameter-decreasing part (third diameter-decreasing part)
314 bottom

What is claimed is:

1. A joined structure, comprising:
a first member;
a second member that is joined together with the first member; and
a pore portion formed on the first member and having an opening in a surface of the first member,
wherein the pore portion is filled with the second member, and
wherein the pore portion comprises an inwardly extending protrusion on an inner periphery thereof.

2. The joined structure according to claim 1,
wherein the pore portion comprising a first diameter-increasing part and a first diameter-increasing part that are continuous with each other,
wherein the first diameter-decreasing part has a larger pore diameter at a position farther away from the surface toward a bottom of the pore portion in a depth direction, and
wherein the first diameter-decreasing part has a smaller pore diameter at a position farther away from the surface toward the bottom in the depth direction, and the protrusion is positioned near the surface.

3. The joined structure according to claim 1,
wherein the pore portion comprises a second diameter-decreasing part, a second diameter-increasing part, and a third diameter-decreasing part that are continuous with one another,
wherein the second diameter-decreasing part has a smaller pore diameter at a position farther away from the surface toward a bottom of the pore portion in a depth direction,
wherein the second diameter-increasing part has a larger pore diameter at a position farther away from the surface toward the bottom in the depth direction, and
wherein the third diameter-decreasing part has a smaller pore diameter at a position farther away from the surface toward the bottom in the depth direction, and the protrusion is positioned inward from the surface toward the bottom.

4. The joined structure according to claim 1,
wherein the first member comprises at least one member selected from the group consisting of metals, thermoplastic resins, and thermosetting resins.

5. The joined structure according to claim 1,
wherein the second member comprises at least one member selected from the group consisting of thermoplastic resins and thermosetting resins.

6. The joined structure according to claim 1,
wherein the pore portion comprises a raised portion surrounding the opening, and
wherein the raised portion extends upward from the surface.

7. The joined structure according to claim 1,
wherein the pore portion has an inclined axis relative to the surface.

8. The joined structure according to claim 1,
wherein the pore portion comprises a plurality of the protrusion.

9. A method for manufacturing a joined structure including a first member and a second member that are joined together, the method comprising:
forming a pore portion having an opening in a surface of the first member;
forming an inwardly extending protrusion on an inner periphery of the pore portion; and
filling the pore portion of the first member with the second member and allowing the second member to solidify.

10. The joined structure according to claim 2,
wherein the first member comprises at least one member selected from the group consisting of metals, thermoplastic resins, and thermosetting resins.

11. The joined structure according to claim 3,
wherein the first member comprises at least one member selected from the group consisting of metals, thermoplastic resins, and thermosetting resins.

12. The joined structure according to claim 2,
wherein the second member comprises at least one member selected from the group consisting of thermoplastic resins and thermosetting resins.

13. The joined structure according to claim 3,
wherein the second member comprises at least one member selected from the group consisting of thermoplastic resins and thermosetting resins.

14. The joined structure according to claim 4,
wherein the second member comprises at least one member selected from the group consisting of thermoplastic resins and thermosetting resins.

15. The joined structure according to claim 2,
wherein the pore portion comprises a raised portion surrounding the opening, and
wherein the raised portion extends upward from the surface.

16. The joined structure according to claim 3,
wherein the pore portion comprises a raised portion surrounding the opening, and
wherein the raised portion extends upward from the surface.

17. The joined structure according to claim 4,
wherein the pore portion comprises a raised portion surrounding the opening, and
wherein the raised portion extends upward from the surface.

18. The joined structure according to claim 5,
wherein the pore portion comprises a raised portion surrounding the opening, and
wherein the raised portion extends upward from the surface.

19. The joined structure according to claim 2,
wherein the pore portion has an inclined axis relative to the surface.

20. The joined structure according to claim 3,
wherein the pore portion has an inclined axis relative to the surface.
